(19) United States
(12) Patent Application Publication
(10) Pub. No.: US 2007/0062820 A1
(43) Pub. Date: Mar. 22, 2007

(54) Fuel cell cogeneration system

(76) Inventor: Eugene S. Smotkin, Crown Point, IN (US)

Correspondence Address: MORRISON & FOERSTER LLP, 12531 HIGH BLUFF DRIVE, SUITE 100, SAN DIEGO, CA, 92130-2040, US

(21) Appl. No.: 11/516,911

(22) Filed: Sep. 6, 2006

Related U.S. Application Data
(60) Provisional application No. 60/714,715, filed on Sep. 6, 2005.

(51) Int. Cl. C02F 1/461

(52) U.S. Cl. 205/742

(57) ABSTRACT

The invention integrates three general operations: the electrolysis of water to produce oxygen and hydrogen gases; the use of the generated oxygen to promote microbial decay of organic substances as in wastewater treatment; and the generation of electrical power by hydrogen-fueled fuel cells. Electrolysis of water provides the molecular oxygen necessary for wastewater treatment, and the hydrogen gas as fuel for a fuel cell to generate power, thus reducing the overall power consumption of the treatment process.

### CROSS-REFERENCE TO RELATED APPLICATIONS

This application claims benefit of provisional application 60/714,715, filed 6 Sep. 2005. The contents of this application is incorporated herein by reference.

### TECHNICAL FIELD

The invention relates to systems for wastewater treatment with reduced energy demand.

### BACKGROUND ART

Wastewater treatment facilities employ a variety of unit operations utilizing the oxygen-promoted microbial decay of soluble and insoluble organic substances. Oxygen is supplied to the treatment reactors by aeration units. Aeration systems fall mainly into two categories: mechanical agitators and bubblers or gas diffusers. Mechanical agitators effect oxygen transfer by causing extreme liquid turbulence at the liquid surface. Gas diffusion systems release compressed air or oxygen beneath the liquid surface in the form of small bubbles. Most wastewater treatment units use ambient air as an oxygen source and are open to the atmosphere, but some units use pure oxygen. The oxygen transport efficiency is characterized by the quantity of oxygen transferred per unit power per unit time; typical units are lbs O₂/(hp-hr). The most efficient presently employed units are about twice as efficient as the least.

The electrolysis of water to produce H₂(g) and O₂(g) is a well-known process and is the primary method by which pure oxygen gas is currently produced. Water electrolysis is also used to generate hydrogen in commercial applications. The cell half-reactions are as follows:

Anodic: 4OH⁻→O₂(g)+2H₂O+4e⁻

Cathodic: 4 H₂O+4e⁻→2H₂(g)+4OH⁻

Conventional electrolyzers use an ion-permeable gas-barrier within the cell electrolyte to prevent the mixture of the product gases. Electrolytes are generally aqueous salt solutions. A conventional electrolyzer unit is shown in FIG. 1. As shown, power is supplied from the power source 10 to send electrons into the cathode chamber 11. Hydrogen is generated from the electrolyte and collected at the exhaust port 12. The hydroxyl ions generated are transferred to the anode chamber 13. The generated oxygen is collected at the exit port 14, and hydrogen ions generated are passed through a gas barrier 15 to the cathode compartment completing the circuit.

Fuel cells are energy conversion devices that convert chemical energy into electricity via electrochemical reactions. Fuel cells are typically categorized by the type of electrolyte used or the temperature range of operation. Polymer Electrolyte Fuel Cells (PEFC) are exemplary. They use a proton conducting polymeric membrane (typically perfluorinated sulfonated polymers such as Nafion™) as the electrolyte. These polymers are composed of a Teflon-like backbone supporting sulfonate groups in a channel-like interior. The sulfonate groups bond positively charged counter ions that are free to exchange. These free counter-ions provide the protonic conduction path. Other fuel cells may use non-polymeric electrolytes.

One type of fuel cell uses hydrogen gas as a fuel. Hydrogen is oxidized to protons and electrons at the fuel cell anode:

2H₂(g)→4H⁺+4e⁻

Oxygen serves as the oxidant and undergoes the cathodic half-reaction:

O₂(g)+4H⁺+4e⁻→2H₂O

The overall cell reaction produces water:

2H₂(g)+O₂(g)→2H₂O

Fuel (H₂) and oxidant (O₂) are supplied to the fuel cell anode and cathode respectively. Ambient air may be used directly as the oxygen source. Both cell half-reactions are catalyzed, typically by platinum. The electrolyte (a proton conductor) conducts the protons generated in the anodic half-cell reaction to the cathode where they react according to the cathodic half-cell reaction. The electrolyte is an electronic insulator and an effective gas separator. Electrons generated at the anode follow an external electronic path to the cathode where they are consumed. The electronic current of the external path is typically used to do useful work or to return power to a grid. The reversible potential difference between anode and cathode is 1.23 volts at standard conditions; as current is drawn the potential is reduced. Multiple fuel cells can be assembled in “stacks” to meet power requirements.

In the case of a polymeric electrolyte, both fuel and oxidant are typically fed in a humidified state, as hydration of the polymeric electrolyte of the fuel cell is essential to maintaining good proton conductivity.

FIG. 2 shows a cross-sectional view of a single-cell fuel cell illustrating its design and operation, showing a sandwich-like design. As shown in the illustrative cell of FIG. 2, the anode and cathode chambers are separated by a polymeric membrane which conducts protons, but not electrons. Humidified hydrogen is fed into the anode past a catalytic electrode, comprising a catalyst 21, typically platinum; and an electron conducting collector 22, where it is oxidized to hydrogen ions and electrons which exit from the catalytic electrode through an external circuit 23, and can be used to drive an energy-consuming process. The electrons pass through the external circuit into the cathodic electrode similarly composed of catalyst 25 and collector 26 to reduce oxygen fed into the cathode chamber to generate water, using the hydrogen ions transported through the polymeric membrane. The overall reaction generates water from hydrogen fuel and oxygen as oxidant.

The fuel cell can also be driven to electrolyze water by feeding water as substrate and supplying a power source in the external circuit as shown in FIG. 3.

Thus, the components useful in the present invention are well known in the present state of the art.

### DISCLOSURE OF THE INVENTION

The invention supplies an advantageous configuration of the foregoing conventional elements to effect energy conservation in wastewater aeration treatment.

The invention incorporates a system to electrolyze water within a wastewater treatment unit operation in such a manner as to provide dissolved molecular oxygen necessary for aerobic processes while utilizing the hydrogen gas and excess oxygen produced by the electrolyzer to drive a fuel cell, which in turn generates power, reducing the overall power consumption of the aeration process.

Thus, in one aspect, the invention is directed to a method to reduce the energy required to generate oxygen for wastewater treatment from electrolysis of water, which method comprises reclaiming excess oxygen used in said wastewater treatment and hydrogen gas generated from said electrolysis of water to operate a fuel cell. The fuel cell produces energy to offset energy used in said electrolysis of water.

In other aspects, the invention is directed to a system for wastewater treatment by aeration which system comprises an electrolysis cell to produce hydrogen and oxygen; a wastewater treatment facility; and at least one fuel cell, wherein the oxygen generated in the electrolytic cell aerates the wastewater and excess oxygen emitted from the wastewater treatment and hydrogen from the electrolytic cell are used as fuel for said fuel cell.

### BRIEF DESCRIPTION OF THE DRAWINGS

FIG. 1 shows a schematic of conventional water electrolysis requiring external power.

FIG. 2 shows a schematic of a polymer electrolyte fuel cell which generates power using hydrogen as fuel and oxygen as the oxidant. Oxygen may simply be supplied by air.

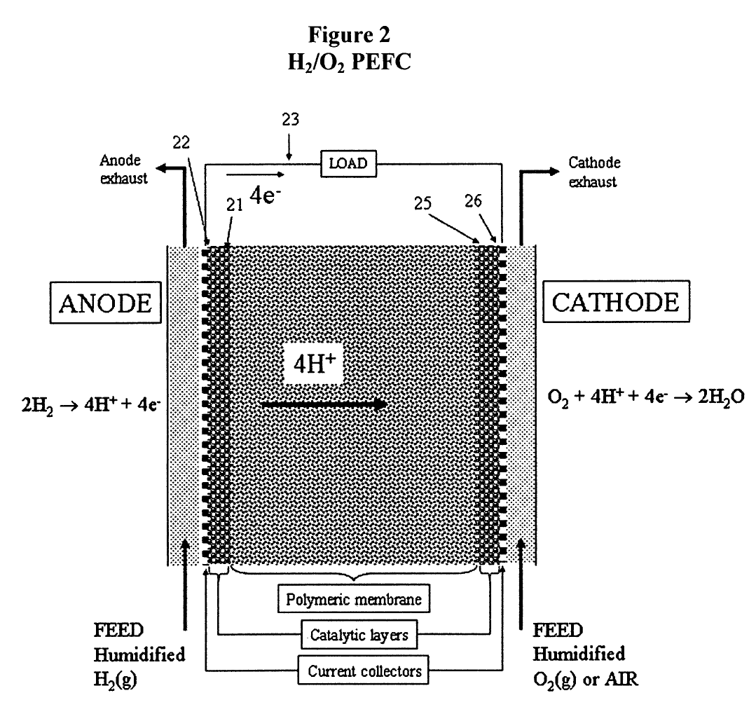

FIG. 3 shows the manner in which the fuel cell of FIG. 2 may be operated in an electrolysis or “galvanic” mode.

FIG. 4 shows a schematic of the method of the invention to reduce power requirements in wastewater treatment.

FIG. 5 shows one embodiment of the invention in which an electrolysis unit is included in a wastewater treatment reactor.

FIG. 6 shows a modification of the embodiment of FIG. 5 wherein an electrolysis unit internal to the wastewater treatment tank is substituted by a fuel cell operated in galvanic mode.

FIG. 7 shows a detail of the fuel cell electrolysis unit shown in FIG. 6.

### MODES OF CARRYING OUT THE INVENTION

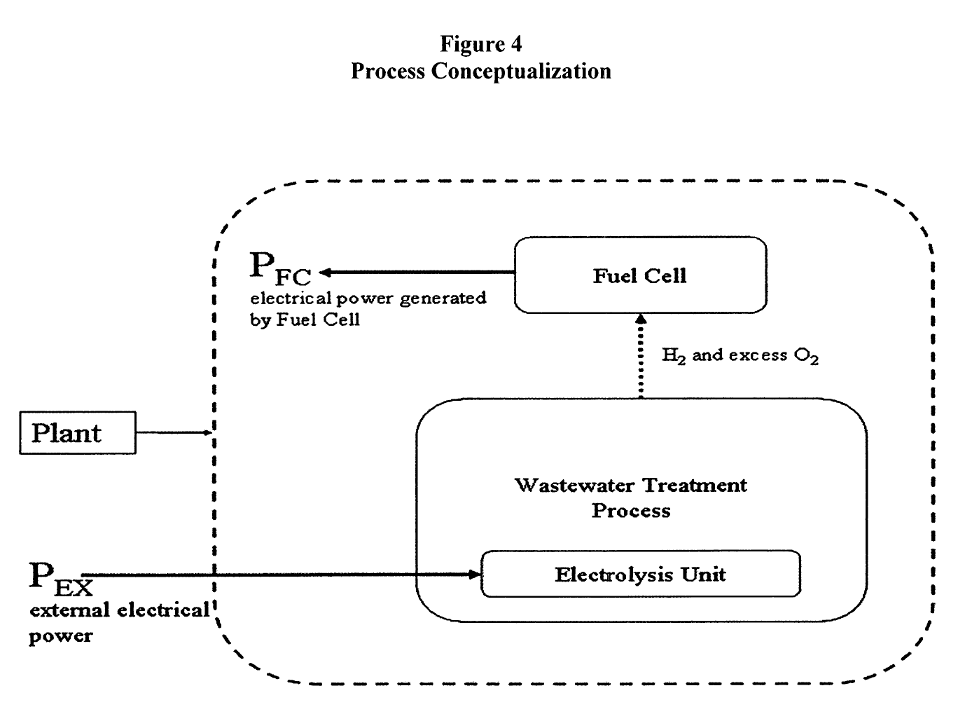

A schematic of the method and system of the invention is shown in FIG. 4. As shown, within a wastewater plant, an electrolysis unit powered by external electrical power (P_{EX}) is used to generate hydrogen and oxygen. The oxygen is pumped through the wastewater treatment process and excess is captured along with the hydrogen generated in the electrolysis unit to drive a fuel cell which generates electrical power (P_{FC}). This power can be used in other applications or can be fed back into the system to reduce the demands for external electrical power.

In one embodiment, electrodes for the electrolytic generation of oxygen are placed directly into the wastewater, which acts as the electrolyte. Anode and cathode compartments are separated so as to maintain gas separation by an ion-permeable gas barrier. Evolved hydrogen and excess oxygen from the electrolysis/treatment process are supplied to the power generating fuel cell, external to the wastewater tank.

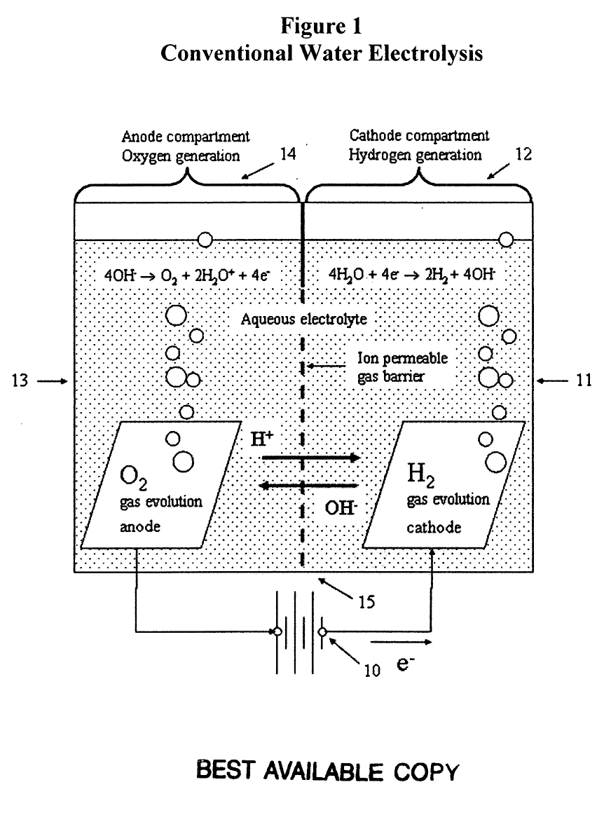

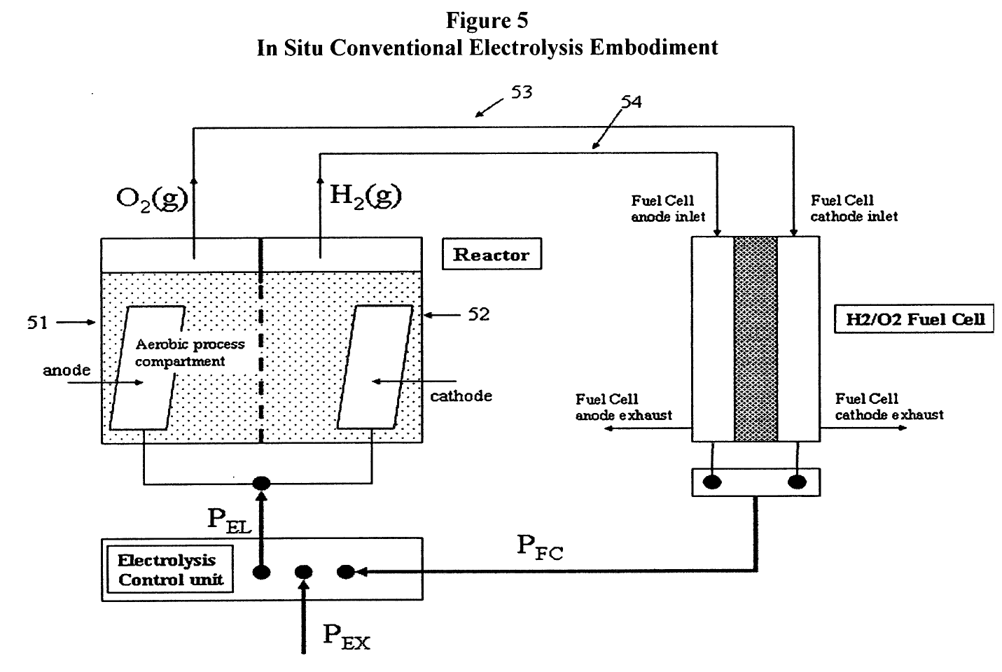

The power generated by the fuel cell can be used in combination with the external source of power to supply power to the electrolysis unit (P_{EL}) or can be used to power other applications. In any event, by capturing the electrolysis products of the wastewater to generate electricity, the overall power demands of the system can be reduced. A diagram of this system is shown in FIG. 5. The wastewater tank operates as an anode in a conventional water electrolysis system shown in FIG. 1. The cathode chamber contains aqueous electrolyte other than wastewater. As shown in FIG. 5, the anode portion of the chamber 51 contains wastewater as the electrolyte. The cathode portion of the chamber 52 contains an aqueous electrolyte other than wastewater. By applying an outside source of power P_{EX}, in conjunction with power generated by the coupled fuel cell, electrolysis is effected in the wastewater/electrode tank by the combined power P_{EL}. The oxygen exiting the anode chamber is pumped through a connector 53 to the cathode inlet of the fuel cell, and the hydrogen generated is pumped through connector 54 to the anode inlet of the fuel cell. Additional oxygen may be supplied to the cathode chamber of the fuel cell in the form of air.

In another embodiment, a conventional electrolysis unit is employed external to the wastewater treatment reactor to generate hydrogen and oxygen. The hydrogen is fed directly to the fuel cell, and oxygen is directed to the wastewater treatment tanks. The oxygen may be bubbled into the treatment system or supplied to the headspace and delivered to the wastewater by surface mechanical agitation. Excess oxygen is directed to the fuel cell. Additional oxygen for the fuel cell operation will be required, and may simply be supplied by directing air into the fuel cell cathode. The energy generated by the fuel cell, as before, may be used to supplement the external energy used to power electrolysis or diverted to other applications.

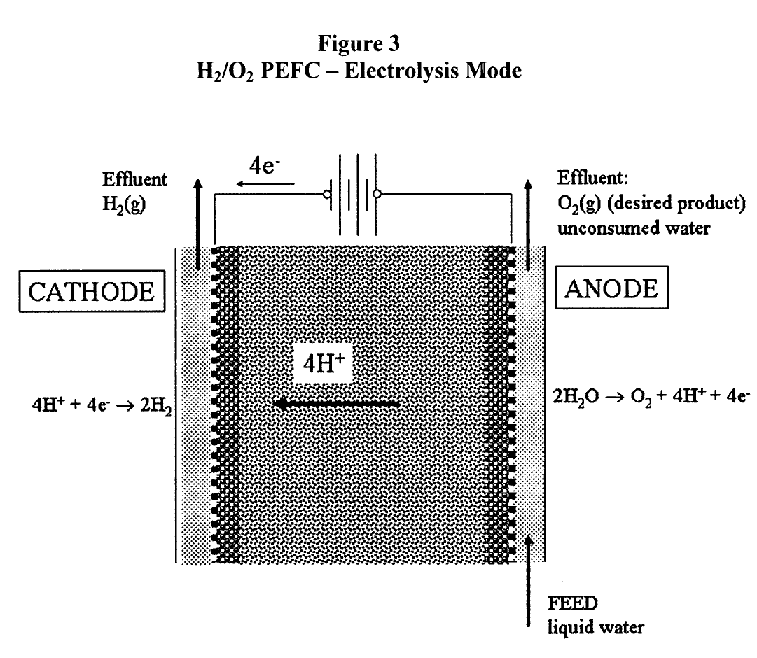

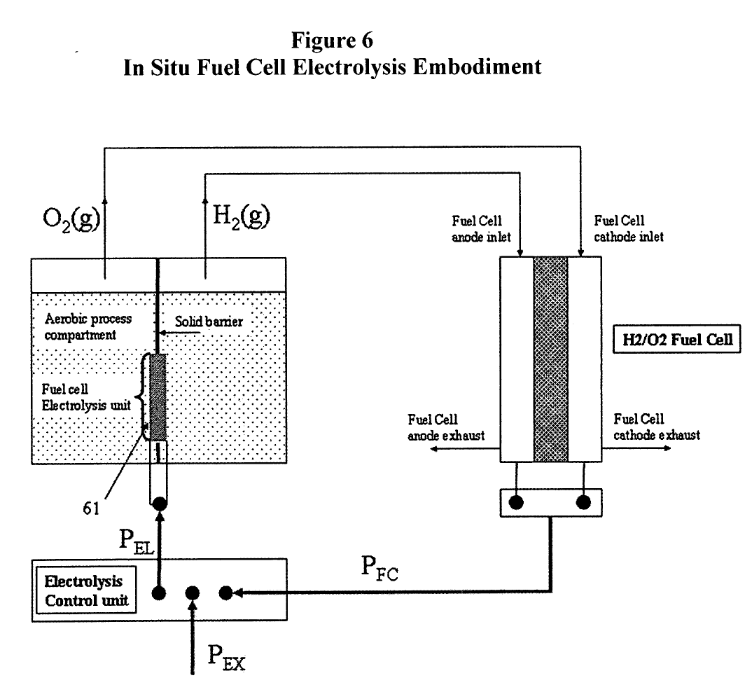

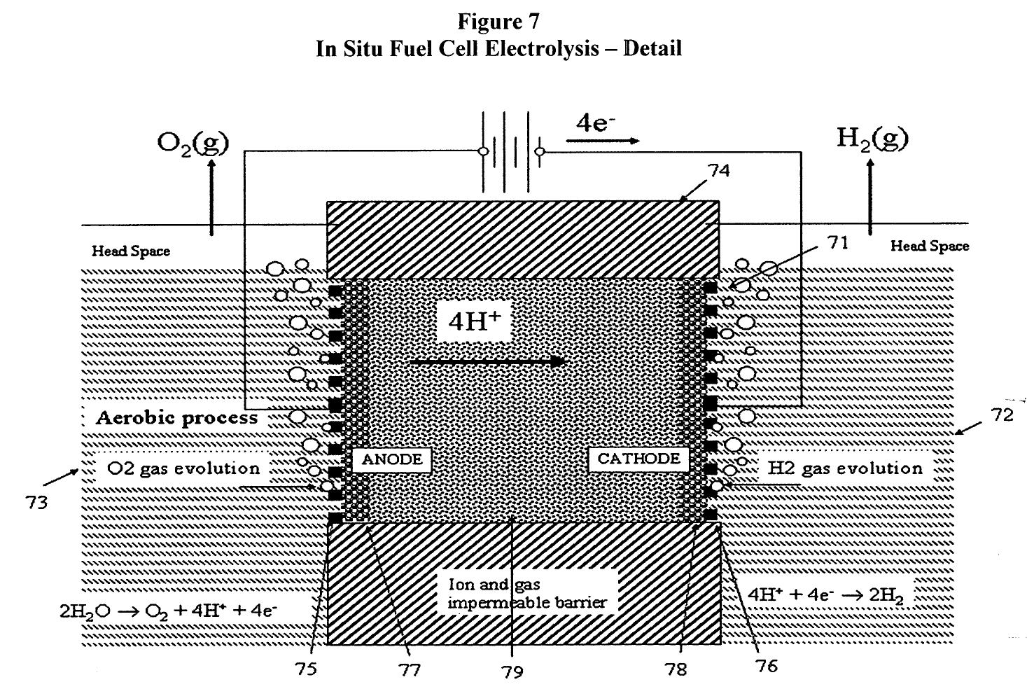

In still another embodiment, a fuel cell operated in the electrolysis mode (as shown in FIG. 3) is incorporated into the wastewater treatment reactor and electrolyzes water in the wastewater directly. FIGS. 6 and 7 depict the fuel cell incorporated into the wall of a treatment tank with the anode 61 facing the wastewater stream. This is shown as an overall scheme in FIG. 6, and FIG. 7 shows the detail of the fuel cell operated in the electrolysis mode as associated with the wastewater treatment reactor.

As shown in detail in FIG. 7, the cathode side 71 may be contacted with a chamber 72 that contains another stage of the treatment process, a source of clean water or humidified environment to maintain hydration of the fuel cell assembly. The wastewater treatment portion of the tank 73 is separated from the chamber 72 containing sufficient water for reaction, by a barrier impermeable to gas and ions 74. As above, the hydrogen and excess oxygen supplied by the galvanically operated fuel cell internal to the tank are collected to operate an external fuel cell to generate power offsetting the external power supply needed to operate the fuel cell in a galvanic mode.

Electronically conductive, porous elements 75 and 76, contact the catalytic regions of the electrolyzer 77 and 78 at sides facing opposite the electrolyte 79. These porous elements provide an electronic conduction path to the catalytic regions while allowing for the transport of reactants and products to those regions.

Of course, rather than being included in the wastewater tanks, the galvanically operated fuel cells may be placed external to the wastewater treatment tanks and only the oxygen generated supplied to the tank, while the hydrogen is diverted to the fuel cell. In all cases, supplementary oxygen required for the operation of the fuel cell may be supplied by air.

1. A method to reduce the energy required to generate oxygen for wastewater treatment from electrolysis of water in an electrolysis system, which method comprises reclaiming excess oxygen used in said wastewater treatment, and hydrogen gas generated from said electrolysis to operate a fuel cell to produce energy, thus offsetting energy used in said electrolysis system.

2. The method of claim 1 wherein oxygen from the electrolysis system is conducted through a waste treatment tank from a proximal end to a distal end, and, wherein oxygen from the distal end is conducted into the cathode of a fuel cell.

3. The method of claim 2 wherein hydrogen generated from the electrolysis system is conducted to the anode of said fuel cell.

4. The method of claim 1 wherein the anode chamber of the electrolysis system comprises a wastewater reactor.

5. The method of claim 1 wherein the electrolysis system is a fuel cell operated in a galvanic mode.

6. The method of claim 5 the anode chamber of said electrolysis system comprises a wastewater reactor.

7. A system for wastewater treatment by aeration which system comprises
a water electrolysis system that produces hydrogen and oxygen;
a wastewater treatment reactor; and
at least one fuel cell,
wherein the oxygen generated in by electrolysis system aerates the wastewater and excess oxygen emitted from the wastewater, and hydrogen from the electrolysis system, are used as oxidant and fuel respectively for said fuel cell.
